(19) United States
(12) Patent Application Publication
(10) Pub. No.: US 2013/0325398 A1
(43) Pub. Date: Dec. 5, 2013

(54) Three-Dimensional Perceived Softness Of Baby Care Products

(71) Applicant: The Procter & Gamble Company, Cincinnati, OH (US)

(72) Inventors: Noriko NAKAGAWA, Singapore (SG); Zhiwu Liang, Kobe (JP); Yoshiko Nakao, Ashlya (JP); Koichi Morimoto, Beijing (CN)

(73) Assignee: The Procter & Gamble Company, Cincinnati, OH (US)

(21) Appl. No.: 13/901,677

(22) Filed: May 24, 2013

Related U.S. Application Data
(60) Provisional application No. 61/652,866, filed on May 30, 2012.

(51) Int. Cl. G01N 35/00

(52) U.S. Cl. CPC G01N 35/00
USPC 702/170; 702/189; 702/179

(57) ABSTRACT

Methods of determining three-dimensional perceived softness of baby care products based on assessed parameters of the products, for use in the design of new baby care products or changes in their raw materials.

### FIELD OF THE INVENTION

Disclosed are methods of determining three-dimensional perceived softness of baby care products, and products exhibiting same.

### BACKGROUND OF THE INVENTION

Baby care products, particularly diapers, are typically designed using empirical methods, basic modeling methods, or consumer testing methods. Such methodologies are time consuming, expensive, and in the case of empirical and modeling efforts, generally do not result in the optimum designs as the predicted results may not show good correlation to the consumer's actual experiences of the products. Typically, for baby care products, an important criteria is the softness of the material because this is one of the key determinates upon which consumers rely on to choose which product to purchase. However, softness is one of the most challenging properties that cannot easily be evaluated by a single technical measurement and therefore requires evaluation by panel testing.

The Kawabata Evaluation System (KES) (S. Kawabata, R. Postle and M. Niwa, “Objective Measurement: Applications to Product Design and Process Control”, ed., The Textile Machinery Society of Japan, Kyoto, 1985 Sep. 5-7.), developed by Dr. Sueo Kawabata at Kyoto University, is an objective panel method widely used in the fabric industry for measuring the mechanical and surface properties of fabric, and from the raw data calculating fabric properties such as, for non-limiting example, smoothness, softness, stiffness, crispness, etc. To date, the KES method has not been applied using multiple parameters, and in particular, this modeling approach has not been employed by the baby care industry to determine softness of baby care products. Given its similarity to fabric, the inventors expected that the perceived softness of a baby care product can also be determined based on analytical methods developed using mainly KES testers. The method would assess different parameters of the baby care product such as, for non-limiting example, drapability, shear, bendability, sound, etc., which can then be used to evaluate the perceived softness of the baby care product. However, it is generally unclear how the assessed parameters correlate to the perceived softness of the baby care product or how many of the assessed parameters are needed to make that determination. Moreover, to test a large number of parameters would be unduly complicated without necessarily ensuring that the key parameters have been selected that will contribute to the most accurate determination of the perceived softness of the baby care product.

Therefore, the need exists for a method to determine the perceived softness of a baby care product based on assessed parameters of the product. There is also a need to identify the assessed parameters of the product that demonstrate a high correlation to the actual softness experienced by the consumer, so that one can use the assessed parameters to determine the perceived softness of new or modified baby care products. Furthermore, the method needs to be simple by incorporating only a few key assessed parameters for convenient and quick measurement, and possible automation. By correlating technical measures to softness rating, such a method can be utilized to test the impact on the perceived softness of the baby care products from changes in the raw materials, more easily understand potential technical improvements to increase softness and eliminate or reduce the use of expensive consumer testing. Lastly, there is a need for baby care products having the perceived softness as determined by the method described herein.

### SUMMARY OF THE INVENTION

The present invention attempts to address one or more of these needs by providing, in a first aspect of the invention, a method for determining the perceived softness of a baby care product comprising the steps of:
(a) assessing at least one core parameter as determined by a drape test, a shear test, a compression test or a bend test;
(b) assessing a surface parameter as determined by a surface friction test; and
(c) determining the perceived softness of the product according to the assessed parameters.

In another aspect, the invention provides for a method for determining the perceived softness of a baby care product comprising the steps of:
(a) assessing at least one core parameter as determined by a drape test, a shear test, a compression test or a bend test;
(b) assessing a surface parameter as determined by a surface friction test;
(bi) assessing a noise parameter as determined by a noise intensity test; and
(c) determining the perceived softness of the product according to the assessed parameters.

In yet another aspect, the invention provides for a method for determining the perceived softness of a baby care composition comprising the steps of:
(a) assessing at least one core parameter as determined by a drape test, a shear test, a compression test or a bend test;
(b) assessing a surface parameter as determined by a surface friction test;
(c) calculating an index value for each of the assessed parameters;
(d) determining the perceived softness of the product according to the calculated index values.

In yet another aspect, the present invention provides for a baby care product having a perceived softness as determined by the method described herein.

In yet another aspect, the present invention provides for a method of designing a baby care product having a perceived softness as determined by the method described herein.

### BRIEF DESCRIPTION OF THE DRAWINGS

While the specification concludes with claims particularly pointing out and distinctly claiming the invention, it is believed that the invention will be better understood from the following description of the accompanying figures wherein:

FIG. 1 shows a cross sectional view of a taped diaper product.

FIG. 2 shows, in an embodiment, a side-view of the drape test of the present invention.

FIG. 3 shows, in an embodiment, a setup of the surface friction test of the present invention.

FIG. 4a-4c shows, in an embodiment, the method of the noise intensity test of the present invention.

FIG. 5 shows a graph of the pressure thickness curve.

FIG. 6 shows a graph of the bend hysteresis curve.

FIG. 7 shows the 3D graph for Example 2.

### DETAILED DESCRIPTION OF THE INVENTION

It is to be understood that the scope of the claims is not limited to the specific instruments, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a”, “an”, and “the” include the plural.

As used herein, any of the terms “comprising”, “having”, “containing”, and “including” means that other steps, ingredients, elements, etc. which do not adversely affect the end result can be added. Each of these terms encompasses the terms “consisting of” and “consisting essentially of”. Unless otherwise specifically stated, the elements and/or equipments herein are believed to be widely available from multiple suppliers and sources around the world.

As used herein, the term “baby care product” is meant to include the finished product, such as for example, diaper, or the raw material, such as, for example, nonwoven materials used for the topsheet and backsheet.

As used herein, the term “coefficient of friction” (MIU) refers to the surface slipperiness. Lower coefficient of MIU indicate less drag and friction on the surface. MIU values can be measured as described in the examples.

As used herein, the term mean “deviation of MIU” (MMD) refers to the surface roughness, and MMD values can be used as an indication of softness of materials. Lower values of surface softness (MMD) indicate less variation or more uniformity on the surface. Surface softness (MMD) values may be measured as described in the examples.

As used herein, the term “about” when placed before a numerical value “X” refers to an interval extending from 10% of X, preferably 5% of X, and even more preferably to an interval extending from 2% of X.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “64.6 gf·cm/cm²” is intended to mean “about 64.6 gf·cm/cm²”.

In one aspect, the present invention is directed to an objective and quantitative measurement of different parameters of a baby care product for determining the softness of the product as perceived by consumers. In particular, the present invention is concerned with the consumers' softness perception in three concepts under which the product is typically used: (i) ultimate softness to cuddle baby's delicate skin, (ii) flexible softness for babies on the move, and (iii) ultimate softness for 12 hours of undisturbed sleep. In order to develop an appreciation of the consumers' actual softness experiences under these concepts, a sort and rate study was conducted using commercially available diapers of varying softness.

Consumer Sort and Rate (S&R) Study

The purpose of this study was to define diaper softness feel benefit in different diapers as experienced by consumers, particularly mothers of babies aged 0-36 months. The three softness concepts (as outlined above) were explained to the mothers. The mothers were asked to evaluate 21 different commercially available diapers by sensory parameters (i.e., touching) and score them for softness on a scale of 1-10, with 10 being extremely soft and 1 being not soft. This step was repeated for each concept. Ten evaluations per diaper were collected and the scores averaged.

The key criterion for the diaper selection is to have a wide range of product softness. In one embodiment, as used herein, the varying softness can be achieved by the mixture of low to top tier diapers sourced from a number of different countries or regions, such as for example, one, two, three, four, five, six, etc. Diapers from different geographies may have varying degrees of softness depending on the consumer needs, and therefore, this approach would ensure that as many different markets are covered so that present invention would have broader applicability. Typically, the assumption is that low tier diapers are less soft and top tier diapers having excellent softness. To ensure that a sufficient range of product softness will exist, substantially equal numbers of products from each tier level are selected. In another embodiment, the varying softness can be achieved utilizing diapers of varying tiers from one country only. This approach would be particularly desirable for application of the present invention to aid in the design of new or modified baby care products targeted for one market (i.e., country). In an embodiment, the present invention provides for a method of designing a baby care product having a perceived softness as determined by the method described herein.

All of the diapers used in the S&R study, with the exception of Examples #2, 7 and 20, are commercially available from various companies, sourced from different countries, and cover a variety of different product tiers, as summarized in Table 1 below. Examples #2, 7 and 20 are prototypes manufactured by the Procter & Gamble Company and not marketed products. However, one skilled in the art can readily identify equivalent products of similar tier levels (i.e., softness) as suitable substitutes for the three prototypes. It will be understood by those skilled in the art that the specific diapers selected to establish the reference for the softness scores of the 21 diapers is not important so long as a sufficient variety of product softness are represented.

TABLE 1
Diaper Information

| | Product | | | |
|---|---|---|---|---|
| No. | Description | Company | Source Country | Tier |
| 1 | Goon Premium | Daio Paper Corp. | Japan | top |
| | Size 2 | | | |
| 2 | Swap Size 2 | Procter & Gamble- | US | top |
| | | Prototype | | |
| 3 | Moony Size 2 | Uni-Charm | Japan | mid |
| 4 | Moony Size 4 | Uni-Charm | Japan | mid |
| 5 | Merries Size 4 | Kao | Japan | mid |
| 6 | Merries Size 2 | Kao | Japan | mid |
| 7 | Bruisers Size 2 | Procter & Gamble- | US | top |
| | | Prototype | | |
| 8 | Pampers ® | Procter & Gamble | US | top |
| | Swaddlers New | | | |
| | Baby Size 2 | | | |
| 9 | Huggies ® Gentle | Kimberly-Clark | US | top |
| | Care Size 2 | | | |
| 10 | BabyLove ® | Uni-Charm | Netherland | mid |
| | Size 4 | | | |
| 11 | BabyLove ® | Uni-Charm | Western | mid |
| | Size 2 | | Europe | |
| 12 | Pampers ® WE | Procter & Gamble | Western | top |
| | Swaddlers | | Europe | |
| 13 | Huggies ® Natural | Kimberly-Clark | US | mid |
| | Fit Size 4 | | | |
| 14 | Tesco Ultra Soft | Tesco | Western | top |
| | Size 2 | | Europe | |
| 15 | Pampers ® Baby | Procter & Gamble | US | mid |
| | Dry M3+ Size 2 | | | |
| 16 | Pampers ® Baby | Procter & Gamble | US | mid |
| | Dry Current Size 4 | | | |
| 17 | Pampers ® Cruisers | Procter & Gamble | US | top |
| | Size 4 | | | |
| 18 | Pampers ® Size 4 | Procter & Gamble | China | low |
| 19 | Pampers ® Size 2 | Procter & Gamble | China | low |
| 20 | Pampers ® Cruisers | Procter & Gamble | US | top |
| | Size 4 | | | |
| 21 | Tesco Super Fit | Tesco | Western | mid |
| | Size 4 | | | |

Table 2, below, summarizes the actual softness scores for the 21 diapers in the three different concepts as well as the overall averages. As can be seen from Table 2, the products trended consistently for softness feel benefit over the 3 concepts. Furthermore, diapers #1-6 (shown in bold) are the gold standard for diapers that have excellent softness, while diapers #16-21 are the least soft and diapers #7-15 represent average level of softness.

TABLE 2
Sort and Rate Study Results

| | Product | | | | |
|---|---|---|---|---|---|
| No. | Description | Average | Skin | Move | Sleep |
| 1 | Goon Premium | 9.2 | 9.5 | 9.1 | 8.9 |
| | Size 2 | | | | |
| 2 | Swap Size 2 | 9.1 | 9.4 | 9.0 | 8.8 |
| 3 | Moony Size 2 | 7.0 | 7.3 | 6.7 | 7.1 |
| 4 | Moony Size 4 | 6.9 | 7.0 | 6.6 | 7.0 |
| 5 | Merries Size 4 | 6.9 | 6.8 | 6.8 | 7.0 |
| 6 | Merries Size 2 | 6.8 | 7.1 | 6.5 | 6.9 |
| 7 | Bruisers Size 2 | 6.7 | 6.8 | 6.8 | 6.5 |
| 8 | Pampers ® | 6.2 | 6.0 | 6.6 | 6.0 |
| | Swaddlers New | | | | |
| | Baby Size 2 | | | | |
| 9 | Huggies ® Gentle | 5.6 | 5.6 | 5.7 | 5.5 |
| | Care Size 2 | | | | |
| 10 | BabyLove ® Size 4 | 5.5 | 5.7 | 5.0 | 5.8 |
| 11 | BabyLove ® Size 2 | 5.5 | 5.6 | 5.3 | 5.6 |
| 12 | Pampers ® WE | 4.8 | 4.5 | 5.3 | 4.7 |
| | Swaddlers | | | | |
| 13 | Huggies ® Natural | 4.2 | 4.2 | 4.1 | 4.3 |
| | Fit Size 4 | | | | |
| 14 | Tesco Ultra Soft | 4.2 | 3.8 | 4.3 | 4.4 |
| | Size 2 | | | | |
| 15 | Pampers ® Baby | 4.1 | 3.9 | 4.2 | 4.1 |
| | Dry M3+ Size 2 | | | | |
| 16 | Pampers ® Baby | 3.9 | 3.7 | 4.3 | 3.8 |
| | Dry Current Size 4 | | | | |
| 17 | Pampers ® Cruisers | 3.8 | 3.5 | 4.3 | 3.7 |
| | Size 4 | | | | |
| 18 | Pampers ® Size 4 | 3.5 | 3.2 | 3.9 | 3.4 |
| 19 | Pampers ® Size 2 | 3.1 | 2.8 | 3.4 | 3.0 |
| 20 | Pampers ® Cruisers | 2.6 | 2.4 | 3.0 | 2.5 |
| | Size 4 | | | | |
| 21 | Tesco Super Fit | 2.9 | 2.9 | 2.5 | 3.2 |
| | Size 4 | | | | |

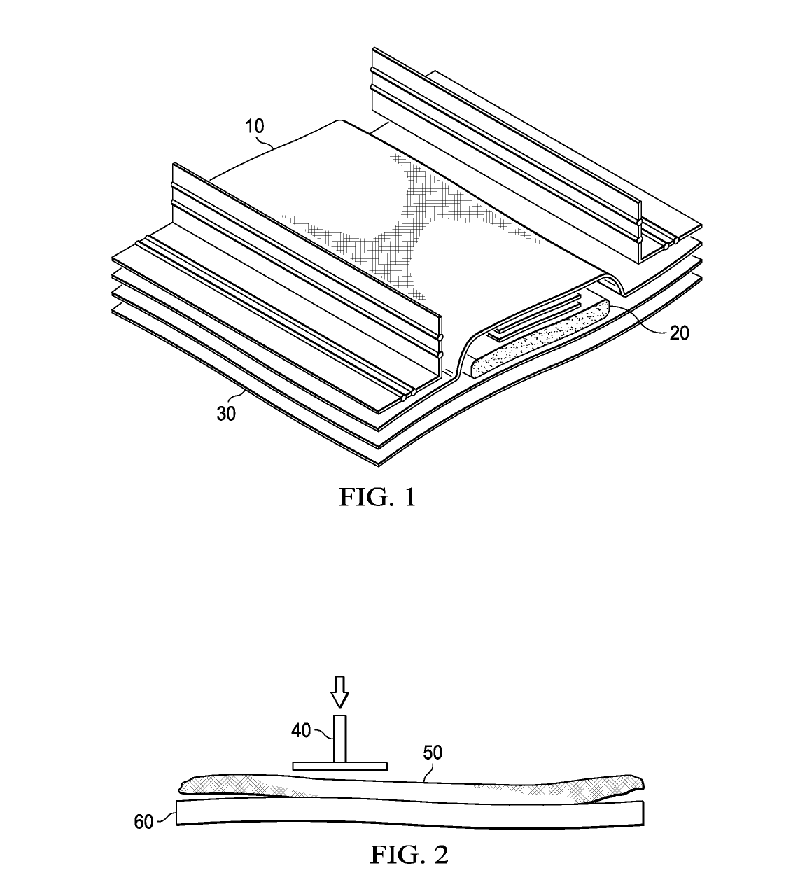

With this ranking information, the inventors then proceeded to assess different parameters of the product and tried to establish a correlation between the assessed parameters and the softness characteristics of the product. Non-limiting examples of some of the parameters that can be tested are: compressibility, bounciness, depression, flexibility, shear, bendability, drapability, surface slipperiness, surface roughness, noise intensity, etc. Moreover, the parameters may be assessed using the entire product, or parts of the product such as, for non-limiting example, the top sheet of the product, the back sheet of the product, the core of the product, the crotch of the product, the front ear of the product, the outer part of the product, the inner part of the product, etc. For example, with reference to FIG. 1, the top sheet (10), the back sheet (30) and the core (20) of a taped diaper product are shown.

The relative importance for each of the assessed parameters was determined for the three concepts. All the assessed parameters can be inputted into an equation, which can then quantify each of the parameter's importance in the softness determination. For non-limiting example, an equation for determining softness can be as follows:

Softness=f{sound average & peak,inner surface(CD:(cross direction)vs MD(machine direction)),coefficient of friction(MIU),mean deviation of MIU(MMD)),drape(WC), compression(WC),outer surface(MIU,MMD)}
R² is the square of R. R is the correlation coefficient between the actual softness rating vs. the predicted softness rating (as determined by the 3D model of the present invention). Typically, R²>0.80 is significant.

The relative importance of each assessed parameter is determined by the coefficient of each factor. For the different concepts (skin, move and sleep), each of the assessed parameters generally contributed the similar percentage to the determination of the softness with the sound parameter being a particularly useful factor for the softness determination.

Furthermore, the inventors found that products which when tested shown similar assessed parameters as the assessed parameters for diapers #1-6, would also be determined to have a high perceived softness. In addition, the inventors discovered that including more than one assessed parameters of the product will tend to increase the accuracy of the determination of perceived softness. Initially, the inventors included up to 16 different assessed parameters, but that was determined to be overly complicated and time consuming, and failed to focus on the key parameters that drove the softness perception. Based on repeated studies, the inventors identified a limited number of key parameters that correlated well to softness. As a result, the inventors were able to simplify the approach by using a three dimensional (3D) parameter space, which uniquely defines the softness for the product. With this approach, each of the axes could be made up of one, two or more assessed parameters, as needed. For instance, in Example 4, the axis of surface comprises of the two parameters of MIU and MMD, and the axis of core comprises of drape and compression.

Method 1—Assessed Parameters

In one embodiment, the present invention provides a method for determining the perceived softness of a baby care product. The method, according to the invention, comprises assessing at least one core parameter as determined by a drape test, a shear test, a compression test or a bend test. The method further comprises the step of assessing a surface parameter as determined by a surface friction test. Any combinations of these different parameters can be assessed as part of the method. It will be appreciated by those of ordinary skill in the art that the term “core parameter” is intended to mean cushiness or bounciness of core as measured by the compression test, drape test, shear test and/or bend test. In addition, the term “surface parameter” is intended to mean surface slipperiness and surface roughness as measured by the surface friction test. The method further comprises the step of determining the perceived softness of the product according to the assessed parameters. For example, the perceived softness of the product may be determined by comparing the raw data from the assessed parameters of the product to the raw data from the assessed parameters of the diapers from the S&R study. Accordingly, the closer the product's raw data from the assessed parameters are to the raw data from the assessed parameters of the diapers #1-6, the higher the perceived softness of the product.

With reference to this embodiment, wherein a first assessed parameter is a first core parameter as determined by a drape test of the product, a second assessed parameter is a second core parameter as determined by a shear test of the product, and a third assessed parameter is a surface parameter as determined by a surface friction test. For example, the surface friction test may be assessed according to a coefficient of friction (MIU), a mean deviation of MIU (MMD), or a combination of MIU and MMD of the product. Further, the surface friction test may be conducted on the top sheet of the product or the back sheet of the product.

Furthermore, according to this embodiment, the product is determined to be soft when having certain values for the assessed parameters. For example, the product may be determined to be soft if it has a work of compression value for the drape test of from about 64.6 gf·cm/cm² to about 102.4 gf·cm/cm², preferably from about 70.3 gf·cm/cm² to about 100.4 gf·cm/cm²; a shear value for the shear test of from about 3.700 N/m/deg to about 8.208 N/m/deg, preferably from about 3.700 N/m/deg to about 5.700 N/m/deg; and a coefficient of friction value (MIU) for the surface friction test of the back sheet of the product from about 3.007 to about 4.288, preferably from about 3.500 to about 4.288.

In another embodiment, the present invention provides a method for determining the perceived softness of a baby care product. The method, according to the invention, comprises assessing at least one core parameter as determined by a drape test, a shear test, a compression test or a bend test. The method further comprises the steps of assessing a surface parameter as determined by a surface friction test and assessing a noise parameter as determined by a noise intensity test. It will be appreciated by those of ordinary skill in the art that the term “noise parameter” is intended to be an indicator of the plastic feel of the material (i.e., lack of softness), which is not preferred by consumers. Any combinations of these different parameters can be assessed as part of the method. The method further comprises the step of determining the perceived softness of the product according to the assessed parameters.

According to this embodiment, wherein a first assessed parameter is a first core parameter as determined by a drape test and a compression test of the product, a second parameter is a surface parameter as determined by a friction surface test, and a third parameter is a noise parameter as determined by a noise intensity test. For example, the surface friction test may be assessed according to a coefficient of friction (MIU), a mean deviation of MIU (MMD), or a combination of MIU and MMD of the product. Further, the surface friction test may be conducted on the top sheet of the product or the back sheet of the product. Further, for example, the noise intensity test may be assessed according to a combination of an average sound intensity and a peak sound intensity of the product.

Furthermore, according to this embodiment, the product is determined to be soft when having certain values for the assessed parameters. For example, the product may be determined to be soft if it has a work of compression value for the drape test of from about 66.4 gf·cm/cm² to about 94.9 gf·cm/cm², preferably from about 80.0 gf·cm/cm² to about 94.9 gf·cm/cm²; a work of compression value for the compression test of from about 33.7 gf·cm/cm² to about 47.5 gf·cm/cm², preferably from about 40.0 gf·cm/cm² to about 47.5 gf·cm/cm²; a coefficient of friction value (MIU) for the surface friction test of the top sheet of the product from about 0.282 to about 0.450, preferably from about 0.400 to about 0.450; a mean deviation of MIU (MMD) for the surface friction test of the top sheet of the product from about 0.015 to about 0.025, preferably from about 0.015 to about 0.020; an average sound intensity for the noise intensity test of from about 52.6 db to about 55.5 db, preferably from about 52.6 db to about 55.0 db; and a peak sound intensity for the noise intensity test of from about 76.5 db to about 81.8 db, preferably from about 76.5 db to about 80.0 db.

Preparation of Test Materials

Depending on the type of parameter being assessed, the test product may be finished product diapers, which include a variety of commercially available brands, or parts of the diapers, such as, for example, the top sheet of the diaper or the back sheet of the diaper. For the top sheet and back sheet, a cold spray made from n-pentane, n-hexane and/or n-heptane may be used to peel them off of the diapers. Preference is for diapers that have less than 6 months shelf life since their production because with time, some degradation, for example, of the glue strength, lotion, etc. could be observed. Further, with diapers older than 6 months, the core of the diaper may absorb humidity. These phenomena may negatively impact the mechanical properties of diaper. Also, efforts are made to select diapers with minimum shrinkage, wrinkles and curves. The diapers are stored in a constant temperature constant humidity (CTCH) room at 23° C.±2° C. and 50%±5% relative humidity over night before use.

Drape Test

The drape test is a tensile tester method that measures the drapability of the finished product diapers to identify the softness characteristics and simulates the consumer's softness rating. “Drape” is a term of art to refer to the ability of a material to bend and drape under the influence of gravity. Materials with good drape are those that show little stiffness and easily deform under the influence of gravity.

Drape of the baby care composition is measured by a tensile tester. Suitable tensile testers are the MTS Insight Series (MTS Systems Corporation, Pittsburgh, Pa.) and the Instron's 5000 series for Low-Force Testing. A 100 Newton load cell is used to make the measurements. A sample stage is a flat rectangular plate, machined of metal harder than 100 HRB (Rockwell Hardness Scale) and has a dimension of about 15 cm×31 cm. This is used for the bottom platen. A suitable stage is drape plate which may have a rectangular gap of about 3 cm×14 cm, with a depth of about 8 mm. Alternatively, a cutout circular hole having a suitable diameter known to those of skilled in the art may be used. A rectangular plunger, is made of hard metal such as, for example, stainless steel. It is about 1 cm×5 cm and has a thickness of about 5 mm with a smooth surface. The following settings are used to make the measurements as summarized in Table 3:

TABLE 3
Drape Test Parameters

| | |
|---|---|
| Data Acquisition Rate: | 50.00 Hz |
| Cross Head Speed: | 0.03 cm/sec |
| Planten Separation: | — (sample thickness (mm) + 8 mm) |
| Plunger Rate: | 0.03 cm/sec |
| Stop Rate: | When load exceeds 1000 gf |
| | (=200 gf/cm², with 5 cm² plunger) |
| Load Units: | gf |

The test is performed in a climate controlled room at standard conditions of 23° C.±2° C. and 50%±5% relative humidity. The test diapers are placed in the climate controlled room at least 2 hrs before the test. The thickness of the sample diaper is measured. Set the planten separation to the minus value of the thickness of the sample diaper plus 8 mm. For example, if the sample thickness is 20 mm, then set the planten separation to “−28 mm”.

With reference to FIG. 2, the test diaper (50) is placed on the drape plate (60) under the plunger (40) to the planten separation position, which is about 2 cm above the diaper fold in the machine direction and centered in the cross-machine direction. The plunger (40) presses the diaper (50) until 1000 g load, then returns to the planten separation position. After the measurement is taken, the load & distance between stage and plunger are recorded. The drape plate and plunger are cleaned with an alcohol wipe and allowed to dry completely between sample diapers. For each test diaper, 1 measurement/1 pad. Usually, 5 replicates are taken for each sample.

Calculating the Drape Parameter:

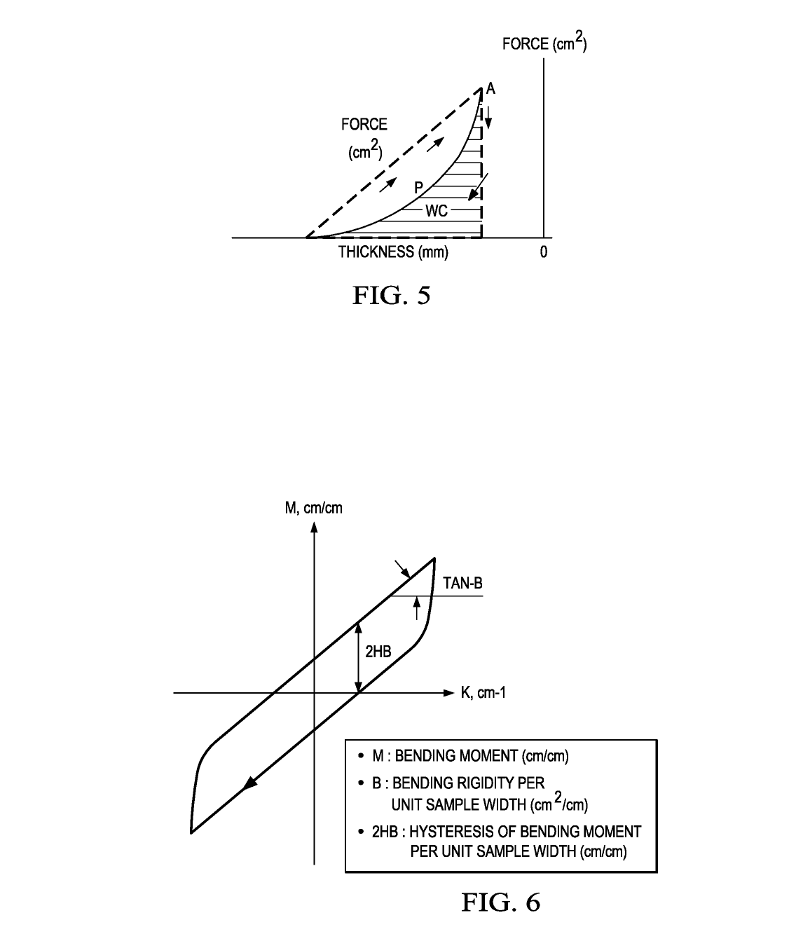

The pressure thickness curve is shown in FIG. 5 and as obtained by the measurement. A normalized drape value can be obtained by calculating the data of the area of WC (compression energy) from integration of P curve (required force gf/cm²) from Ho to Hm. Integration of this area (WC)=integ(hm, ho) P dx (i.e., WC=gf cm/cm²). This is calculated for each sample diaper measured and the value is reported as gf·cm/cm².

Shear Test:

In the following test, determination of the product's perceived softness is made by an assessment of its shear stiffness. Shear stiffness is highly correlated with the tightness of the materials used to construct the product, which is highly correlated with the perceived softness in the product. Test products are tested using a Kawabata Shear Tester KES FB1-AUTO-A (Kato Tech Corporation Ltd. Japan). In this machine, test diapers are placed between two clamps which are movable relative to each other. For each test diaper, 5 replicas are used. The Shear Tester applies opposing, parallel forces to the test diapers, until a maximum offset angle is reached. The test diapers are subjected to cyclic shear deformation, the maximum displacement (shear angle) being 8°, a tension of 10 gf/cm, and a shear deformation at a shear strain rate of 0.5°/sec. All testing is conducted in a climate controlled room at standard conditions of 23° C.±2° C. and 50%±5% relative humidity. Further details on the procedures for conducting the shear test are well known to those skilled in the art or is described in US Patent Publication No. US2006/142728, which is incorporated by reference. The following settings are used to make the measurements as summarized in Table 4:

TABLE 4
Shear Test Parameters

| | |
|---|---|
| Shear Angle: | 8° |
| Shear Stiffness values of G: | Shear force rigidity. (gf/cm · degree) |
| | Force (gf) required to shear per 1 cm |
| | width material, per degree. |
| Shear Stiffness values of 2HG: | Hysteresis (gf/cm) of shear curve (go |
| | and return) at 0.5° |

Calculating the Shear Test Parameter:

Based on the width of the test diapers, the shear stiffness (G) is calculated. Shear G is calculated by the force, thickness of sample, and degree of shear based on the following equation:

G=gf/cm*degree

This is calculated for each sample diaper measured and the value is reported as N/m/deg, whereby the units are converted from gf to N and cm to m. The Kawabata Shear Tester can report the units in either format.

Compression Test:

Assessment of the compression of the sample diaper is measured by a tensile tester. Suitable tensile testers for this measurement are single or dual column tabletop systems for low-force applications of 1 kN to 10 kN, or systems for higher force tensile testers. Suitable tensile testers may be the MTS Insight Series (MTS Systems Corporation, Pittsburgh, Pa.) and the Instron's 5000 series for Low-Force Testing. Alternatively, assessment of the product may be measured by the KES-FB 3 system for Compression (Kato Tech Corporation Ltd. Japan).

A 100 Newton load cell is used to make the measurements. A sample stage is flat rectangular plate, machined of metal hard than 100 HRB (Rockwell Hardness Scale) and has the dimensions of 15 cm×31 cm. This is used for the bottom planten. The compression head is made of hard metal, such as, for example, stainless steel. It is about 1.596 cm in diameter and about 0.3 cm thick with a smooth surface. The following settings are used to make the measurements as summarized in Table 5 below:

TABLE 5
Compression Test Parameters

| | |
|---|---|
| Data Acquisition Rate: | 50.00 Hz |
| Platen Separation: | — (thickness of sample mm + 1 mm) |
| Compression Area: | 2 cm² |
| Compression Head Rate: | 0.02 cm/sec |
| Compression Stop 1: | load exceeds 400 gf |
| Load Units: | gf |

The test is performed in a climate controlled room at standard conditions of 23° C.±2° C. and 50%±5% relative humidity. The sample diapers are placed in the climate controlled room at least 2 hrs before the test. The thickness of the sample diaper is measured. Set the planten separation to the minus value of the thickness of the sample diaper plus 1 mm. For example, if the sample thickness is 8 mm, then set the planten separation to “−9 mm”. Cut the sample diaper into 8 cm×8 cm square. 5 measurements were obtained for each sample diaper.

The planten separation position is set at—(thickness of sample mm+1 mm). The sample diaper is placed on the planten and aligned with the compression area under the compression head, without billows or folds in the sample diaper. After measurement is taken, the load and extension values for each sample are saved. The planten and compression head are cleaned with an alcohol wipe and allowed to dry completely between sample diapers. For each diaper, 1 measurement/pad are measured.

Calculating the Compression Parameter:

The pressure thickness curve is shown in FIG. 5 and as obtained by the measurement. Calculate the data of area of WC (compression energy) from integration of P curve (required force gf/cm²) from Ho to Hm. The slope of the compression curve is derived in the following manner (i.e., WC=gf·cm/cm²). Integration of this area (WC)=integ(hm, ho) P dx. This is calculated for each sample diaper measured and the value is reported as gf·cm/cm².

Bend Test (Stiffness Measure):

Assessment of the product bend may be measured by a KES bending tester KES-FB2-AUTO-A (Kato Tech Corporation Ltd. Japan). The deformation mode is a pure bending between the curvature K=0.5 cm⁻¹ and 1.5 cm⁻¹. The effective dimension for the measurement is 20 cm in length and 1 cm in width (rectangular). Therefore, the test sample is taken to have at least 20 cm in length and 1 cm in width. The bending rate is 0.5 cm⁻¹/sec. As a result, the bending hysteresis curve is shown in FIG. 6 and as obtained by the measurement below. The horizontal axis shows the curvatures K cm⁻¹ and the vertical axis shows the bending moment per unit width M (gf·cm/cm). Measurements are carried out in the MD and CD directions of the same test sample. The average bending force is the mean value of the above bending force obtained from the measurements about the MD and CD directions of the test sample.

Calculating the Bend Parameter:

The bend parameter can be calculated as follows. Bending Force (B)=dM/dK, where M is bending force(gf) per 1 cm width of a sample. K is curvature (cm⁻¹) of range 0.5 cm⁻¹ and 1.5 cm⁻¹. B is the average slope of this range. This is calculated for each sample diaper measured and the value is reported as N·m²/m.

Surface Friction Test:

Surface friction test measures the coefficient of friction (MIU) of a surface of baby care product by moving a probe at preset velocity across product surface over which coefficient of friction is determined. The test can be conducted on either the top sheet of the product or the back sheet of the product.

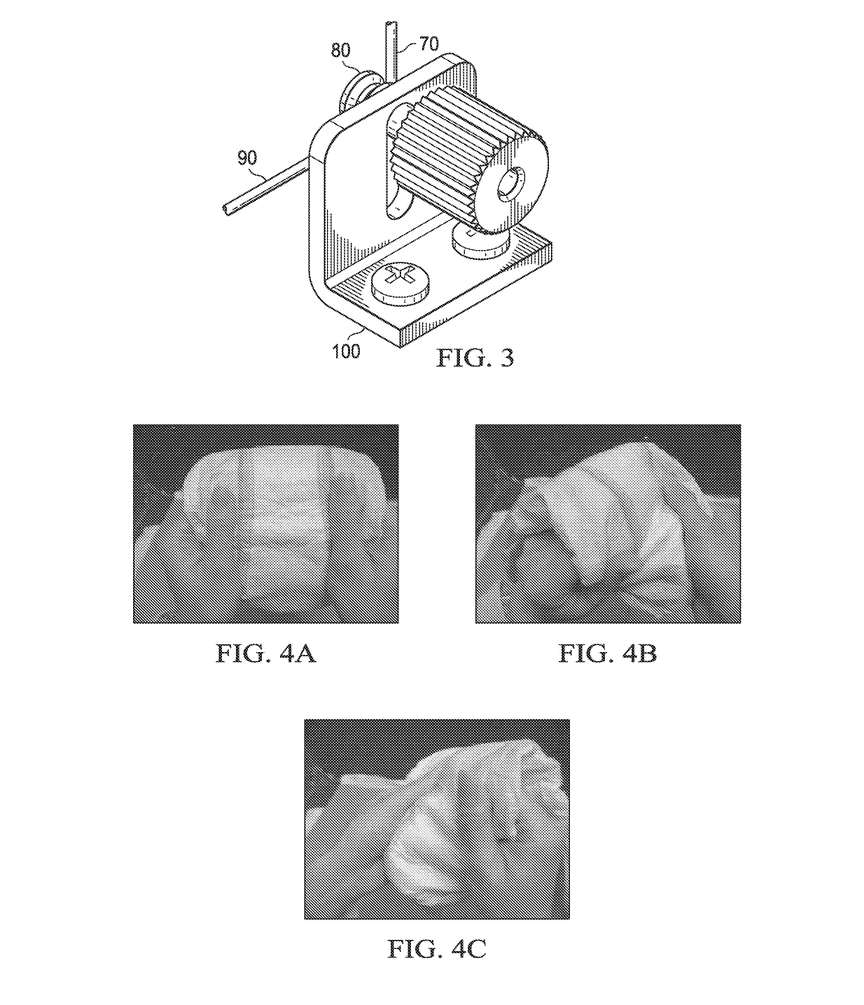

The probe may be a circular sled with a 25 mm diameter and made from glass filter having a porosity of 25-50 micron. The probe has a 25 gram force (g·f) load cell, but additional weight can be added, up to 50 g·f. Any Suitable tensile testers which can work with MTS test works ver. 4.0 software and with appropriate load cell range of samples tested between 10% and 90% of the capacity of the load cell range can be used. For example, the Kawabata Evaluation (KES-SE) surface friction electronic instrument (Kato Tech Corporation Ltd. Japan) can be used. Alternatively, assessment of the product may be measured by the KES-FB 4 system for Surface Friction and Roughness (Kato Tech Corporation Ltd. Japan). With reference to FIG. 3, the height of the pulley (80) on the stage (100) can be adjusted to align the string (90) perpendicularly at the pulley (80). The crosshead arm height to the stage (100) is adjusted to about 15-20 cm (measured from the bottom of the cross arm to the top of the stage) to ensure that the probe remains parallel to and in contact with the product during the measurement. Fix the string (70), which is connected with the probe (80), in the center of the upper jaw of the tensile tester. Set the test product on the stage and fix it into position with tape to prevent it from moving. Further details on the procedures for conducting the friction test are well known to those skilled in the art or is described in US Patent Publication No. US2006/142728, which is incorporated by reference. The following settings are used to make the measurement as summarized in Table 6 below:

TABLE 6
Surface Friction Test Parameter

| | |
|---|---|
| T2 (Kinetic Measure): | The tensile tester moves 40 mm |
| | and collects data from 15 mm |
| | movement to 35 mm movement. |
| Total Time: | 40 sec |
| Test Rate: | 60 mm/min |

The probe is placed on the product and attached to the load cell. The crosshead is moved until the load cell registers between ˜0±0.5 gf, with the string having almost no tension, but not loose. The tensile tester moves 40 mm and collects data for the Force (Average force in gf) and Weight (25 gf weight of the probe without any added weight on it) from 15 mm movement to 35 mm movement. For each product, 1 measurement/pad, and 5 pad/product are measured.

Calculating Coefficient of Friction (MIU) and Mean Deviation of MIU (MMD):

Friction properties are reported with MIU (coefficient of friction) and MMD (mean deviation of MIU) by the following equation. A coefficient of friction (MIU), can be obtained by dividing F/W, where F is the frictional force and W is the weight. A mean deviation of MIU (MMD) can be obtained by taking the mean deviation of MIU. This is calculated for each sample diaper measured and the value is reported without units. Generally, smaller MIU and MMD mean less friction and less roughness for the product, indicating softer surface.

Noise Intensity Test:

This test measures the impact that sound has on the overall softness rating. An LA-5111 ONO Sokki microphone can be used to take the measurement inside a sealed box. Alternatively, other types of microphone known to those skilled in the art can also be used. In one approach, the product is twisted at the crotch part and the sound is recorded for approximately 2 secs (see FIG. 4a-4c). Alternatively, the product can be twisted at other parts, such as, for example, at the topsheet and the backsheet. Recordings for both the average sound intensity/level and the peak sound intensity/level are made.

Calculating average sound intensity and peak sound intensity parameters:

Peak value (Lpeak) is calculated by taking logarithm of ratio of AC output of max sound pressure observed and AC output at 2×10⁻⁵ Pa (base pressure).

Lpeak=20*log¹⁰ [fA(imax)/f0]

fA: maximum of AC output (sound pressure) observed

f0: AC output at 2×10⁻⁵ Pa

Average is calculated by taking logarithm of integration of square of relative sound pressure (normalized with base pressure) over measurement time.

LAeq,T=10 log 10[(t₂−t₁)⁻¹*Integ(t₂,t₁)P_{A}²(t)/P₀²dt]P_{A}(t):sound pressure

P₀: 20 uPa (base pressure)

t₁: time to start measurement

t₂: time to end measurement

T: integration time (t₂−t₁)

This is calculated for each sample diaper measured and the value is reported as decibel (db). Sound measurement was done for 5 replicates at least and taken the average. RSD was less than 10%.

Statistical Analysis:

The above described tests can be performed on a range of different baby care products quantifying the results for each case. In doing so, a population of statistical measurements will be created which can be analyzed by known statistical techniques such as, for example, design of experiments, linear regression, partial least squares (PLS) regression, significant test, optimization simulation, etc. The statistical techniques are all well-known to those skilled in the art and therefore can be readily applied to determine if the results obtained are statistically significant.

Method 2—Calculated Index Values

In another aspect, as an alternative to analyzing the raw data of the assessed parameters, the present invention provides for an analysis based on the calculated index values of the assessed parameters. The “calculated index values” means a calculated value on 0 to 10 scale from the raw data of the assessed parameters as measured by the instruments. Typically, a 0 rating indicates poor softness results and a 10 rating indicates excellent softness result. The software used to perform the calculation is JMP version 9.0 from SAS Company (Cary, N.C.) designed to run experiments and simulations and conduct statistical analysis. Although, different softwares, such as for example, Graphics Software (Kylebank Software Ltd., UK), SigmaPlot Software (Aspire Software International, Asburn, Va.), SAS Graph Software (SAS), etc. can be used. The benefits of using the calculated index values allows for the standardization of the order of magnitude for the different assessed parameters. The models were developed using raw data (not index). The index values for the raw data were calculated to plot into the 3D graph. The index values can be calculated as follows:

Index value=(top value−the value of the sample)/(top value−worst value)*10

The calculated index value can be calculated from raw data from one or two assessed parameters. Alternatively, the calculated index value can be based on two assessed parameters. For example, sound parameter is a combination of the average sound and the peak sound parameters. First, calculate the index values for each parameter into 0-10 scale. Next, combine the calculated index values based on the coefficient of the model. For example, contribution ratio of sound average and sound peak is “ave:peak=10.4:9.2”. Accordingly, the equation to obtained the combined sound parameter is =average sound index*10.4/19.6+peak sound index*9.2/19.6. It has been determined that for some measurements, the input of two assessed parameters provides for a better prediction of the perceived softness. For example, core is another parameter that can be based on two assessed parameters, such as, for example. with core compression and core drape. In this way, more factors are incorporated and shown in one axis in 3D graph. In addition, JMP software can plot the calculated index values in a three-dimensional (3D) graph to provide a visual representation of regions of softness. It is understood by those skilled in the art that the 3D graph can be generated with other applications, such as, for example, Excel (Microsoft).

The method, according to this embodiment, comprises assessing at least one core parameter as determined by a drape test, a shear test, a compression test or a bend test. The method further comprises the step of assessing a surface parameter as determined by a surface friction test. Any combinations of these different parameters can be assessed as part of the method. The method further comprises the steps of calculating an index value for each of the assessed parameters and determining the perceived softness of the product according to calculated index values. For example, the perceived softness of the product may be determined by comparing the calculated index values from the assessed parameters of the product to the calculated index values from the assessed parameters of the diapers from the S&R study. Accordingly, the closer the product's calculated index values are to the calculated index values from the assessed parameters of the diapers #1-6, the higher the perceived softness of the product.

Referring to this embodiment, wherein the surface friction test may be assessed, for example, according to a coefficient of friction (MIU), a mean deviation of MIU (MMD), or a combination of MIU and MMD of the product. Further, the surface friction test may be conducted on the top sheet of the product or the back sheet of the product.

According to this method, wherein the first assessed parameter is a first core parameter as determined by a drape test of the product, a second assessed parameter is a second core parameter as determined by a shear test of the product, and a third assessed parameter is a surface parameter as determined by a surface friction test according to a combination of a coefficient of friction (MIU) and a mean deviation of MIU (MMD) of the top sheet of the product.

Furthermore, according to this embodiment, the product is determined to be soft when having certain values for the calculated index values. For example, the product may be determined to be soft if it has a calculated index value for the drape test of from about 3.8 to about 10.0, preferably from about 7.0 to about 10.0; a calculated index value for the shear test of from about 6.4 to about 10.0, preferably from about 7.0 to about 10.0; and a calculated index value for the surface friction of from about 6.1 to about 10.0, preferably from 7.0 to about 10.0.

In another embodiment, the method further comprises the steps, after the step of assessing the surface parameter, of assessing a thickness of the product and assessing a noise parameter as determined by a noise intensity test according to a combination of an average sound intensity and a peak sound intensity of the product. Thickness of topsheet and backsheet may highly impact on the product softness and the thickness of the materials such as topsheet and backsheet can be measured using compression method, as described above.

With reference to this embodiment, wherein a first assessed parameter is a core parameter as determined by a drape test and a compression test of the product; a second assessed parameter is a surface parameter as determined by a surface friction test according to a combination of a coefficient of friction (MIU) and a mean deviation of MIU (MMD) of the top sheet of the product; and a third assessed parameter is a noise parameter as determined by a noise intensity test according to a combination of an average sound intensity and a peak sound intensity of the product.

According to this embodiment, the product is determined to be soft when having certain calculated index values. For example, the product may be determined to be soft if it has a calculated index value for the core parameter of from about 4.5 to about 10.0, preferably from about 8.0 to about 10.0; a calculated index value for the surface parameter of from about 5.9 to about 10.0, preferably from about 8.0 to about 10.0; and a calculated index value for the noise parameter of from about 5.7 to about 10.0, preferably from about 8.0 to about 10.0.

Alternatively, any combinations of the different assessed parameters can be used to make the determination of softness. For example, in another embodiment, the first assessed parameter can be core flexibility (shear and drapability), the second assessed parameter can be topsheet friction, and the third assessed parameter is backsheet friction.

In yet another aspect, the present invention also provides for baby care products having a perceived softness as determined by the methods described herein.

In order that the invention described herein may be more fully understood, the following examples are set forth. It should be understood that these examples are for illustrative purposes only and are not to be construed as limiting this invention in any manner.

### Example 1

### Correlation of Raw Data from Assessed Parameters (Shear, Drape and Surface Friction Tests) to Softness

The objective of this example is to establish a correlation between the raw data of three assessed parameters and the softness property of the product. The three assessed parameters include a first core parameter as determined by a drape test, a second core parameter as determined by a shear test and a third surface parameter as determined by a surface friction test. In order to establish the correlation, the inventors measured the parameters for a variety of commercially available diapers of varying known softness, which include a number of the diapers used in the S&R study. Accordingly, all the diapers underwent a drape test, a shear test and surface friction test, as described herein above, and the raw data results are reported in Table 7 below.

TABLE 7
Summary of Raw Data for Example 1

| | Product | Drape | Shear | |
|---|---|---|---|---|
| No. | Description | (gf · cm/cm²) | (N/m/deg) | Surface (MIU) |
| 1 | Japan Goon | 102.4 | 8.208 | 4.288 |
| | Premium (S) | | | |
| 2 | Goon Premium | 94.0 | 7.390 | 3.968 |
| 3 | MerriesL-size | 70.3 | 3.700 | 3.835 |
| 4 | Merries M | 64.6 | 4.100 | 4.278 |
| 5 | Goon L-size | 95.8 | 5.700 | 3.007 |
| 6 | Goon M | 100.4 | 4.200 | 3.089 |
| 7 | Sinatra Bi base | 56.6 | 7.752 | 1.886 |
| 8 | Sinatra Tri 30gTS | 78.0 | 9.538 | 1.796 |
| | Lower compression | | | |
| 9 | Pampers ® Cruisers | 60.9 | 7.238 | 1.980 |
| | E5 EBL LZ | | | |
| 10 | Mitsui | 60.6 | 8.042 | 2.998 |
| 11 | Bico 70/30 | 66.0 | 7.048 | 2.842 |
| 12 | Huggies ® | 69.1 | 4.982 | 1.786 |
| 13 | T5 | 77.2 | 7.842 | 1.597 |
| 14 | Olympus | 63.7 | 7.400 | 3.147 |
| 15 | L8 current | 63.9 | 7.200 | 2.169 |
| 16 | L9 Base | 65.4 | 9.200 | 2.416 |
| 17 | Merries S | 93.4 | 8.438 | 2.828 |
| 18 | GENKI | 58.9 | 6.400 | 2.694 |
| 19 | B5+ FQN 18gsm | 75.6 | 9.283 | 2.544 |
| 20 | B5+ FQN 18gsm + | 78.3 | 11.134 | 2.282 |
| | EBL LZ | | | |
| 21 | Huggies ® Gentle | 74.3 | 13.396 | 1.870 |
| | Care | | | |
| 22 | Pampers ® M1 | 69.4 | 12.169 | 1.825 |
| 23 | B5 current Mitsui | 67.9 | 9.911 | 2.901 |
| | ESSB 25gsm | | | |
| 24 | GooN S | 83.6 | 11.293 | 2.670 |
| 25 | L9 Ascania | 61.3 | 9.900 | 2.439 |
| 26 | B5 WE Euskurchen | 68.7 | 12.340 | 2.231 |
| | plant | | | |
| 27 | Sinatra Tri base | 41.2 | 12.512 | 1.955 |
| 28 | Sinatra Tri 30g TS | 57.3 | 11.356 | 1.869 |
| 29 | Stealth control | 43.6 | 14.234 | 1.024 |
| 30 | Stealth P10 | 50.1 | 12.316 | 2.365 |
| 31 | Ascania | 49.0 | 12.438 | 3.034 |
| 32 | HEC | 45.4 | 16.294 | 3.006 |
| 33 | Bico 50/50 | 52.7 | 10.598 | 1.743 |

Goon brand diapers from Daio Paper Corp. (Japan).

Merries brand diapers from Kao (Japan).

Pampers® brand diapers from Procter & Gamble (US).

Huggies® brand diapers from Kimberly-Clark (US).

GENKI brand diapers from Nepia (Japan).

Ascania brand diapers from Ascania (Germany).

Stealth brand diapers from Procter & Gamble (US).

With reference to Table 7, diapers #1-6 (shown in bold) are the gold standard for having excellent softness, diapers #27-33 are the least soft and diapers, and diapers #18-20 represent average level of softness. The raw data of the assessed parameters can then serve as a reference against which newly assessed parameters of modified or new baby care products can be compared in order to determine their perceived softness.

### Example 2

### Correlation of Calculated Index Values from Assessed Parameters (Shear, Drape and Surface Friction Tests) to Softness

The raw data from Example 1 were inputted into the JMP software, and the corresponding index values were calculated. A table summarizing the calculated index values is provided in Table 8 below.

TABLE 8
Summary of Calculated Index Values for Example 1

| | | Y-axis | Z-axis | X-axis |
|---|---|---|---|---|
| | Product | Drape | Shear | Surface |
| No. | Description | (Index Value) | (Index Value) | (Index Value) |
| 1 | Japan Goon | 10.0 | 6.4 | 10.0 |
| | Premium (S) | | | |
| 2 | Goon Premium | 8.6 | 7.1 | 9.0 |
| 3 | MerriesL-size | 4.8 | 10.0 | 8.6 |
| 4 | Merries M | 3.8 | 9.7 | 10.0 |
| 5 | Goon L-size | 8.9 | 8.4 | 6.1 |
| 6 | Goon M | 9.7 | 9.6 | 6.3 |
| 7 | Sinatra Bi base | 2.5 | 6.8 | 2.6 |
| 8 | Sinatra Tri | 6.0 | 5.4 | 2.4 |
| | 30gTS Lower | | | |
| | compression | | | |
| 9 | Pampers ® | 3.2 | 7.2 | 2.9 |
| | Cruisers E5 | | | |
| | EBL LZ | | | |
| 10 | Mitsui | 3.2 | 6.6 | 6.0 |
| 11 | Bico 70/30 | 4.1 | 7.3 | 5.6 |
| 12 | Huggies ® | 4.6 | 9.0 | 2.3 |
| 13 | T5 | 5.9 | 6.7 | 1.8 |
| 14 | Olympus | 3.7 | 7.1 | 6.5 |
| 15 | L8 curent | 3.7 | 7.2 | 3.5 |
| 16 | L9 Base | 4.0 | 5.6 | 4.3 |
| 17 | Merries S | 8.5 | 6.2 | 5.5 |
| 18 | GENKI | 2.9 | 7.9 | 5.1 |
| 19 | B5+ FQN | 5.6 | 5.6 | 4.7 |
| | 18gsm | | | |
| 20 | B5+ FQN | 6.1 | 4.1 | 3.9 |
| | 18gsm + EBL | | | |
| | LZ | | | |
| 21 | Huggies ® | 5.4 | 2.3 | 2.6 |
| | Gentle Care | | | |
| 22 | Pampers ® M1 | 4.6 | 3.3 | 2.5 |
| 23 | B5 current | 4.4 | 5.1 | 5.8 |
| | Mitsui ESSB | | | |
| | 25gsm | | | |
| 24 | Goon S | 6.9 | 4.0 | 5.0 |
| 25 | L9 Ascania | 3.3 | 5.1 | 4.3 |
| 26 | B5 WE | 4.5 | 3.1 | 3.7 |
| | Euskurchen | | | |
| | plant | | | |
| 27 | Sinatra Tri base | 0.0 | 3.0 | 2.9 |
| 28 | Sinatra Tri 30g | 2.6 | 3.9 | 2.6 |
| | TS | | | |
| 29 | Stealth control | 0.4 | 1.6 | 0.0 |
| 30 | Stealth P10 | 1.5 | 3.2 | 4.1 |
| 31 | Ascania | 1.3 | 3.1 | 6.2 |
| 32 | HEC | 0.7 | 0.0 | 6.1 |
| 33 | Bico 50/50 | 1.9 | 4.5 | 2.2 |

*Source of diapers same as above for Table 7.

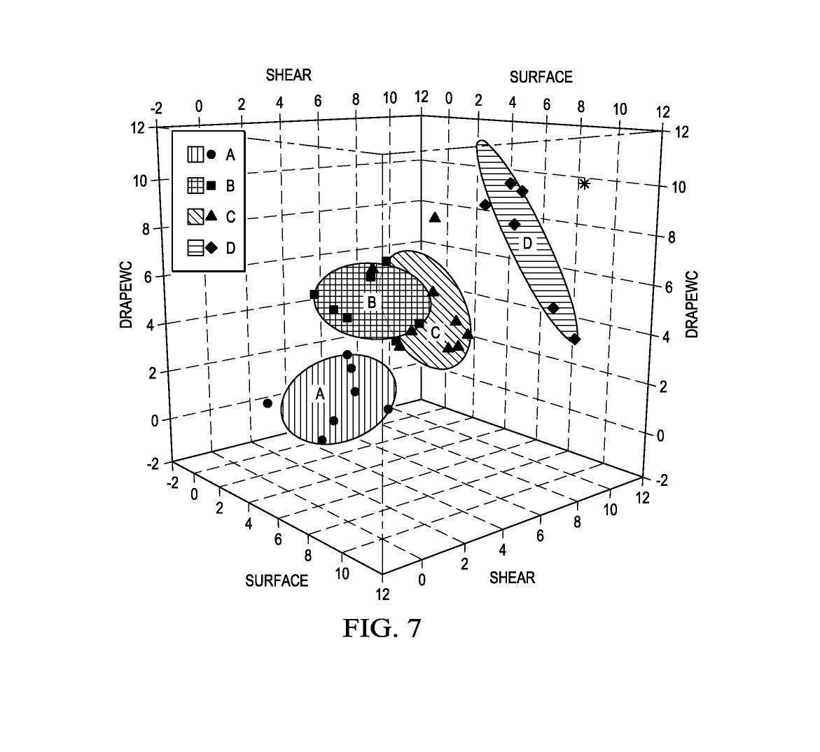

The JMP software was then used to plot the three assessed parameters in a 3D graph to serve as a visual aid. With this example, only one assessed parameter was used for each axis. With reference to FIG. 7, the x-axis represents the surface friction test, the y-axis represents the drape test, and the z-axis represents the shear test. The bubble D (horizontal lines) represents diapers with the highest softness rating, while the bubble A (vertical lines) represents least softness diapers. The bubble B (crisscrossed lines) represents average softness, and the bubble C (diagonal lines) represents average with better shear results. Therefore, test products that fall within the bubble D region would be assessed as having the excellent softness property highly desired by consumers. This demonstrates that the method according to the present invention is effective for determining the perceived softness of baby care products.

### Example 3

### Correlation of Raw Data from Assessed Parameters (Drape, Compression, Surface, and Noise) to Softness

The objective of this example is also to establish a correlation between the raw data of three assessed parameters and the softness property of the product. Alternatively, instead of relying on three parameters, as in Example 1, the inventors herein have assessed six parameters of the products. The six assessed parameters include a first core parameter as determined by a drape test and a compression test, a second surface parameter as determined by a surface friction test according to a combination of a coefficient of friction (MIU) and a mean deviation of the MIU (MMD), and a third noise parameter as determined by a noise intensity test according to a combination of an average sound intensity and a peak sound intensity. The inventors assessed all six parameters for the same products used in the S&R study. Accordingly, all the diapers underwent a drape test, a compression test, a surface friction test, and a noise intensity test, as described herein above, and the raw data results are summarized in Table 9 below.

TABLE 9
Summary of Raw Data Results for Example 3

| | | | | | Mean | Average | Peak |
|---|---|---|---|---|---|---|---|
| | | | | Coefficient | Deviation | Sound | Sound |
| | Product | Compression | Drape | of Friction | of MIU | Intensity | Intensity |
| No. | Description | (gf · cm/cm²) | (gf · cm/cm²) | (MIU) | (MMD) | (db) | (db) |
| 1 | Goon | 41.5 | 92.1 | 0.309 | 0.015 | 52.6 | 77.0 |
| | Premium | | | | | | |
| | Size 2 | | | | | | |
| 2 | Swap | 39.5 | 92.0 | 0.282 | 0.020 | 53.0 | 76.5 |
| | Size 2 | | | | | | |
| 3 | Moony | 37.2 | 71.7 | 0.355 | 0.018 | 55.5 | 79.0 |
| | Size 2 | | | | | | |
| 4 | Moony | 39.4 | 66.4 | 0.380 | 0.017 | 55.1 | 79.7 |
| | Size 4 | | | | | | |
| 5 | Merries | 37.7 | 84.6 | 0.356 | 0.017 | 55.3 | 81.8 |
| | Size 4 | | | | | | |
| 6 | Merries | 33.7 | 94.9 | 0.324 | 0.016 | 55.3 | 79.8 |
| | Size 2 | | | | | | |
| 7 | Bruisers | 31.2 | 70.7 | 0.287 | 0.020 | 53.3 | 82.0 |
| | Size 2 | | | | | | |
| 8 | Pampers ® | 40.5 | 81.9 | 0.385 | 0.024 | 54.3 | 80.4 |
| | Swaddlers | | | | | | |
| | New Baby | | | | | | |
| | Size 2 | | | | | | |
| 9 | Huggies ® | 47.5 | 90.2 | 0.427 | 0.016 | 54.7 | 83.1 |
| | Gentle Care | | | | | | |
| | Size 2 | | | | | | |
| 10 | BabyLove ® | 37.6 | 62.4 | 0.325 | 0.015 | 58.0 | 85.4 |
| | Size 4 | | | | | | |
| 11 | BabyLove ® | 39.2 | 59.7 | 0.310 | 0.017 | 56.4 | 78.4 |
| | Size 2 | | | | | | |
| 12 | Pampers ® | 40.1 | 74.8 | 0.419 | 0.025 | 56.0 | 79.9 |
| | WE | | | | | | |
| | Swaddlers | | | | | | |
| 13 | Huggies ® | 40.7 | 69.0 | 0.383 | 0.021 | 57.9 | 83.3 |
| | Natural Fit | | | | | | |
| | Size 4 | | | | | | |
| 14 | Tesco Ultra | 43.8 | 60.2 | 0.394 | 0.026 | 56.1 | 82.0 |
| | Soft Size 2 | | | | | | |
| 15 | Pampers ® | 32.1 | 82.1 | 0.377 | 0.018 | 56.6 | 82.3 |
| | Baby Dry | | | | | | |
| | M3+ Size 2 | | | | | | |
| 16 | Pampers ® | 37.0 | 67.0 | 0.441 | 0.022 | 56.4 | 80.5 |
| | Baby Dry | | | | | | |
| | Current | | | | | | |
| | Size 4 | | | | | | |
| 17 | Pampers ® | 29.1 | 61.7 | 0.373 | 0.027 | 56.5 | 79.1 |
| | Cruisers | | | | | | |
| | Size 4 | | | | | | |
| 18 | Pampers ® | 32.5 | 71.7 | 0.445 | 0.024 | 59.9 | 85.8 |
| | Size 4 | | | | | | |
| 19 | Pampers ® | 28.9 | 76.8 | 0.418 | 0.025 | 59.7 | 87.2 |
| | Size 2 | | | | | | |
| 20 | Pampers ® | 20.4 | 59.3 | 0.412 | 0.025 | 54.8 | 85.7 |
| | Cruisers | | | | | | |
| | Size 4 | | | | | | |
| 21 | Tesco | 30.8 | 53.7 | 0.383 | 0.021 | 57.9 | 83.3 |
| | Super Fit | | | | | | |
| | Size 4 | | | | | | |

*Source of diapers same as above for Table 1.

With reference to Table 9, diapers #1-6, and 7 (shown in bold) are the gold standard for having excellent softness, while diapers 18-20 are the least soft and diapers #13-16 represent average level of softness. The inclusion of more parameters permitted for a more accurate determination of the softness of the products.

### Example 4

### Correlation of Calculated Index Values from Assessed Parameters (Drape, Compression, Surface, and Noise) to Softness

The raw data from Example 3 were inputted into the JMP software, and the corresponding index values were calculated. A table summarizing the calculated index values is provided in Table 10 below.

TABLE 10
Summary of Calculated Index Values for Example

| | | Z-axis | Y-axis | X-axis |
|---|---|---|---|---|
| | Product | Noise | Surface | Core |
| No. | Description | (Index Value) | (Index Value) | (Index Value) |
| 1 | Goon | 9.8 | 9.8 | 8.7 |
| | Premium | | | |
| | Size 2 | | | |
| 2 | Swap | 9.7 | 10.1 | 8.4 |
| | Size 2 | | | |
| 3 | Moony Size 2 | 6.8 | 6.9 | 5.0 |
| 4 | Moony Size 4 | 6.8 | 5.9 | 4.5 |
| 5 | Merries Size 4 | 5.7 | 7.0 | 7.1 |
| 6 | Merries Size 2 | 6.6 | 9.0 | 8.1 |
| 7 | Bruisers Size 2 | 7.1 | 9.8 | 4.1 |
| 8 | Pampers ® | 7.0 | 3.8 | 7.0 |
| | Swaddlers | | | |
| | New Baby | | | |
| | Size 2 | | | |
| 9 | Huggies ® | 5.6 | 3.6 | 9.3 |
| | Gentle Care | | | |
| | Size 2 | | | |
| 10 | BabyLove ® | 2.2 | 9.0 | 3.7 |
| | Size 4 | | | |
| 11 | BabyLove ® | 6.4 | 9.3 | 3.5 |
| | Size 2 | | | |
| 12 | Pampers ® | 6.1 | 1.9 | 5.9 |
| | WE | | | |
| | Swaddlers | | | |
| 13 | Huggies ® | 4.9 | 6.1 | 5.1 |
| | Natural Fit | | | |
| | Size 4 | | | |
| 14 | Tesco Ultra | 5.0 | 2.8 | 4.2 |
| | Soft Size 2 | | | |
| 15 | Pampers ® | 4.6 | 5.6 | 5.9 |
| | Baby Dry M3+ | | | |
| | Size 2 | | | |
| 16 | Pampers ® | 5.5 | 1.6 | 4.3 |
| | Baby Dry | | | |
| | Current Size 4 | | | |
| 17 | Pampers ® | 6.1 | 3.6 | 2.4 |
| | Cruisers Size 4 | | | |
| 18 | Pampers ® | 0.6 | 0.8 | 4.4 |
| | Size 4 | | | |
| 19 | Pampers ® | 0.2 | 2.0 | 4.7 |
| | Size 2 | | | |
| 20 | Pampers ® | 4.4 | 2.2 | 0.9 |
| | Cruisers Size 4 | | | |
| 21 | Tesco Super | 3.2 | 4.7 | 1.4 |
| | Fit Size 4 | | | |

*Source of diapers same as above for Table 1.

With this example, it may be easier to compare normalized values of noise, surface and core parameters, individually or combined, to rank the perceived softness of the diapers. Also, this approach can be powerful as it incorporates other parameters beyond touch, such as, for example, sound, to evaluate perceived diaper softness. With reference to Table 10, diapers #1-6 (shown in bold) are the gold standard for having excellent softness, while diapers 18-21 are the least soft and diapers #13-16 represent average level of softness. This example demonstrates the flexibility of the method of the present invention to plug in any of the assessed parameters for softness determination of baby care products.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for determining the perceived softness of a baby care product comprising the steps of:
(a) assessing at least one core parameter as determined by a drape test, a shear test, a compression test or a bend test;
(b) assessing a surface parameter as determined by a surface friction test; and
(c) determining the perceived softness of the product according to the assessed parameters.

2. The method of claim 1, wherein:
a first assessed parameter is a first core parameter as determined by a drape test of the product;
a second assessed parameter is a second core parameter as determined by a shear test of the product; and
a third assessed parameter is a surface parameter as determined by a surface friction test according to a coefficient of friction (MIU), a mean deviation of MIU (MMD), or a combination of MIU and MMD of the product.

3. The method of claim 2, wherein the surface friction test assesses a top sheet or a back sheet of the product.

4. The method of claim 3, wherein the product is determined to be soft when having:
a work of compression value for the drape test of from about 64.6 gf·cm/cm² to about 102.4 gf·cm/cm², preferably from about 70.3 gf·cm/cm² to about 100.4 gf·cm/cm²;
a shear value for the shear test of from about 3.700 N/m/deg to about 8.208 N/m/deg, preferably from about 3.700 N/m/deg to about 5.700 N/m/deg; and
a coefficient of friction value (MIU) for the surface friction test of the back sheet of the product from about 3.007 to about 4.288, preferably from about 3.500 to about 4.288.

5. The method of claim 1, further comprising the step (bi) of assessing a noise parameter as determined by a noise intensity test.

6. The method of claim 5, wherein:
the first assessed parameter is a core parameter as determined by a drape test and a compression test of the product;
the second assessed parameter is a surface parameter as determined by a surface friction test according to a coefficient of friction (MIU), a mean deviation of MIU (MMD), or a combination of MIU and MMD of the product; and
the third assessed parameter is a noise parameter as determined by a noise intensity test according to a combination of an average sound intensity and a peak sound intensity of the product.

7. The method of claim 6, wherein the surface friction test assesses a top sheet or a back sheet of the product.

8. The method of claim 7, wherein the composition is determined to be soft when having:
a work of compression value for the drape test of from about 66.4 gf·cm/cm² to about 94.9 gf·cm/cm², preferably from about 80.0 gf·cm/cm² to about 94.9 gf·cm/cm²;
a work of compression value for the compression test of from about 33.7 gf·cm/cm² to about 47.5 gf·cm/cm², preferably from about 40.0 gf·cm/cm² to about 47.5 gf·cm/cm²;
a coefficient of friction value (MIU) for the surface friction test of the top sheet of the product from about 0.282 to about 0.450, preferably from about 0.400 to about 0.450;
a mean deviation of MIU (MMD) for the surface friction test of the top sheet of the product from about 0.015 to about 0.025, preferably from about 0.015 to about 0.020;
an average sound intensity for the noise intensity test of from about 52.6 db to about 55.5 db, preferably from about 52.6 db to about 55.0 db; and
a peak sound intensity for the noise intensity test of from about 76.5 db to about 81.8 db, preferably from about 76.5 db to about 80.0 db.

9. A method for determining the perceived softness of a baby care product comprising the steps of:
(a) assessing at least one core parameter as determined by a drape test, a shear test, a compression test or a bending test;
(b) assessing a surface parameter as determined by a surface friction test;
(c) calculating an index value for each of the assessed parameters; and
(d) determining the perceived softness of the composition according to the calculated indexed values.

10. The method of claim 9, wherein the surface friction test is assessed according to a coefficient of friction (MIU), a mean deviation of MIU (MMD), or a combination of a MIU and a MMD of the product.

11. The method of claim 10, wherein the surface friction test assesses a top sheet or a back sheet of the product.

12. The method of claim 11, wherein:
a first assessed parameter is a first core parameter as determined by a drape test of the product;
a second assessed parameter is a second core parameter as determined by a shear test of the product; and
a third assessed parameter is a surface parameter as determined by a surface friction test according to a combination of a coefficient of friction (MIU) and a mean deviation of MIU (MMD) of the top sheet of the product.

13. The method of claim 12, wherein the product is determined to be soft when having:
a calculated index value for the drape test of from about 3.8 to about 10.0, preferably from about 7.0 to about 10.0;
a calculated index value for the shear test of from about 6.4 to about 10.0, preferably from about 7.0 to about 10.0; and
a calculated index value for the surface friction of from about 6.1 to about 10.0, preferably from 7.0 to about 10.0.

14. The method of claim 11, further comprising the steps of
(bi) assessing a thickness of the product; and
(bii) assessing a noise parameter as determined by a noise intensity test according to a combination of an average sound intensity and a peak sound intensity of the product.

15. The method of claim 14, wherein the thickness of the product is determined by a top sheet thickness or a bottom sheet thickness.

16. The method of claim 15, wherein
a first assessed parameter is a core parameter as determined by a drape test and a compression test of the product;
a second assessed parameter is a surface parameter as determined by a surface friction test according a combination of a coefficient of friction (MIU) and a mean deviation of MIU (MMD) of the top sheet of the product; and
a third assessed parameter is a noise parameter as determined by a noise intensity test according to a combination of an average sound intensity and a peak sound intensity of the product.

17. The method of claim 16, wherein the product is determined to be soft when having:
a calculated index value for the core parameter of from about 4.5 to about 10.0, preferably from about 8.0 to about 10.0;
a calculated index value for the surface parameter of from about 5.9 to about 10.0, preferably from about 8.0 to about 10.0; and
a calculated index value for the noise parameter of from about 5.7 to about 10.0, preferably from about 8.0 to about 10.0.

18. A baby care product having a perceived softness as determined by the method of claim 1.

19. A baby care product having a perceived softness as determined by the method of claim 9.

20. A method for designing a baby care product, using the method of claim 1 to determine its perceived softness.

21. A method for designing a baby care product, using the method of claim 9 to determine its perceived softness.
